(19) United States
(12) Patent Application Publication
(10) Pub. No.: US 2022/0164857 A1
(43) Pub. Date: May 26, 2022

(54) INFORMATION PROCESSING DEVICE, INFORMATION PROCESSING SYSTEM, AND RECORDING MEDIUM

(71) Applicant: TOYOTA JIDOSHA KABUSHIKI KAISHA, Toyota-shi (JP)

(72) Inventors: Toshiki KASHIWAKURA, Ohta-ku (JP); Yukiya Sugiyama, Toyota-shi (JP); Kano Asai, Okazaki-shi (JP); Hideo Hasegawa, Nagoya-shi (JP)

(73) Assignee: TOYOTA JIDOSHA KABUSHIKI KAISHA, Toyota-shi (JP)

(21) Appl. No.: 17/455,805

(22) Filed: Nov. 19, 2021

(30) Foreign Application Priority Data
Nov. 24, 2020 (JP) 2020-194657

(51) Int. Cl. G06Q 30/06

(52) U.S. Cl. CPC G06Q 30/0633; G01D 5/244; G06Q 30/0605

(57) ABSTRACT

An information processing system includes a rotation sensor configured to detect the number of rotations performed by an object that rotates at a time of being consumed; and a processor configured to acquire the number of rotations from the rotation sensor, determine, based on the number of rotations from the rotation sensor, whether a consumed quantity of the object is at or greater than a predetermined threshold, and perform a predetermined process regarding replenishment of the object, in a case where the consumed quantity of the object is determined to be at or greater than the predetermined threshold.

### CROSS REFERENCE TO THE RELATED APPLICATION

This application claims the benefit of Japanese Patent Application No. 2020-194657, filed on Nov. 24, 2020, which is hereby incorporated by reference herein in its entirety.

### BACKGROUND

### Technical Field

The present disclosure relates to an information processing device, an information processing system, and recording medium recorded with a program.

### Description of the Related Art

There is disclosed a system according to which a printing/vending machine detects a remaining amount of each of various consumable items for printing, such as paper and ink that are consumed by image printing, and transmits the remaining amount to a service center management device, and the service center management device manages the remaining amount of each of the consumable items for printing (for example, Japanese Patent Laid-Open No. 2001-160180).

An aspect of the disclosure is aimed at providing an information processing device, an information processing system, and recording medium recorded with a program that facilitate stock management of an object that rotates at the time of being consumed.

### SUMMARY

An aspect of the present disclosure is an information processing device comprising a processor configured to:

acquire, from a rotation sensor, number of rotations performed by an object that rotates at a time of being consumed;

determine, based on the number of rotations from the rotation sensor, whether a consumed quantity of the object is at or greater than a predetermined threshold; and

perform a predetermined process regarding replenishment of the object, in a case where the consumed quantity of the object is determined to be at or greater than the predetermined threshold.

Another aspect of the present disclosure is an information processing system comprising:

a rotation sensor configured to detect number of rotations performed by an object that rotates at a time of being consumed; and

a processor configured to
acquire the number of rotations from the rotation sensor,
determine, based on the number of rotations from the rotation sensor, whether a consumed quantity of the object is at or greater than a predetermined threshold, and

perform a predetermined process regarding replenishment of the object, in a case where the consumed quantity of the object is determined to be at or greater than the predetermined threshold.

Another aspect of the present disclosure is a non-transitory computer-readable recording medium recorded with a program for causing a computer to:

transmit, to a server, identification information of a rotation sensor configured to detect number of rotations performed by an object that rotates at a time of being consumed, and identification information of a user; and

receive, from the server, a notification according to a predetermined process regarding replenishment of the object, in a case where a consumed quantity of the object is determined by the server to be at or greater than a predetermined threshold based on the number of rotations from the rotation sensor.

According to the present disclosure, stock management of an object that rotates at the time of being consumed may be facilitated.

### BRIEF DESCRIPTION OF THE DRAWINGS

FIG. 1 is a diagram illustrating an example configuration of a stock management system according to a first embodiment;

FIG. 2 is a diagram illustrating an example of an outer appearance of a housing of the sensor device;

FIG. 3 is an example of a cross-section of the body part of the housing of the sensor device;

FIG. 4 is a diagram illustrating an example of an outer appearance of the fixing part of the housing of the sensor device;

FIG. 5 is a diagram illustrating an example of a hardware configuration of the center server, the sensor device, and the user terminal according to the first embodiment;

FIG. 6 is a diagram illustrating an example of a functional configuration of the center server, the sensor device, and the user terminal according to the first embodiment;

FIG. 7 is an example of a setting screen on the user terminal;

FIG. 8 is an example of information pieces stored in the user information database of the center server;

FIG. 9 is a diagram illustrating an example of information pieces stored in the product information DB 15 in the center server;

FIG. 10 is an example of a flowchart of a user information transmission process by the user terminal;

FIG. 11 is an example of a flowchart of a user information management process by the center server; and

FIG. 12 is an example of a flowchart of a rotation number monitoring process by the center server.

### DESCRIPTION OF THE EMBODIMENTS

An aspect of the present disclosure is an information processing device including a processor. The processor is configured to acquire, from a rotation sensor, the number of rotations performed by an object that rotates at a time of being consumed, and determine, based on the number of rotations from the rotation sensor, whether a consumed quantity of the object is at or greater than a predetermined threshold. The processor performs a predetermined process regarding replenishment of the object, in a case where the consumed quantity of the object is determined to be at or greater than the predetermined threshold.

For example, the information processing device is a server. For example, the processor is a central processing unit (CPU). For example, objects that rotate at a time of being consumed are, but not limited to, roll-shaped daily necessities, such as a toilet roll, plastic wrap, aluminum foil, kitchen towel, packing tape, cellophane tape and the like. The rotation sensor may count the number of rotations of a target object by rotating together with the target object, or may be a sensor that counts the number of rotations of the target object while remaining in a state where the rotation sensor itself does not rotate.

According to an aspect of the present disclosure, the consumed quantity of an object that rotates at a time of being consumed is monitored by monitoring the number of rotations of the object detected by the rotation sensor, and the predetermined process regarding replenishment of the object is performed when the consumed quantity of the object exceeds the predetermined threshold. Stock management of the object may thus be facilitated for a user.

According to an aspect of the present disclosure, as the predetermined process, the processor may notify a user terminal associated with the rotation sensor of consumption of the object. The user may thus grasp that the object is consumed and does not remain much. For example, the user may plan and replenish the object by purchasing a product equivalent to the object before the stock of the object ends.

According to an aspect of the present disclosure, as the predetermined process, the processor may place an order to a predetermined store such that a predetermined quantity of product equivalent to the object is delivered to a predetermined location that is specified by a user associated with the rotation sensor. Accordingly, when the object is consumed in a quantity at or greater than a predetermined threshold, a predetermined quantity of product equivalent to the object is automatically ordered, and the object may be automatically replenished without the user himself/herself taking any action. The store to which the order is placed may be any of a store specified by the user, a store that sells the same product as the object at a lowest price, or a store that sells a product of a same item as the object and with a lowest unit price, for example. Furthermore, the processor may notify a user terminal associated with the rotation sensor that the order is placed. The user may thus grasp that a product equivalent to the object will be automatically delivered.

According to an aspect of the present disclosure, the rotation sensor may be attachable to the object. In this case, the rotation sensor may also be attached to an object corresponding to a different product. The information processing device may further include a storage configured to hold, for a plurality of products, the predetermined threshold related to the consumed quantity used to determine whether to perform the predetermined process regarding replenishment. The processor may be further configured to acquire information about a first product corresponding to the object from a user terminal associated with the rotation sensor, and identify the predetermined threshold for the first product. Accordingly, in the case where the rotation sensor can be mounted on a plurality of products, the information processing device may monitor the consumed quantity or a remaining quantity in relation to the first product corresponding to the object where the rotation sensor is mounted.

Another aspect of the present disclosure may be specified as an information processing system including the above-described rotation sensor and the above-described processor. The information processing system includes the rotation sensor configured to be attached to an object that rotates at a time of being consumed and to detect the number of rotations performed, and the processor configured to acquire the number of rotations from the rotation sensor, determine, based on the number of rotations from the rotation sensor, whether a consumed quantity of the object is at or greater than a predetermined threshold, and perform a predetermined process regarding replenishment of the object, in a case where the consumed quantity of the object is determined to be at or greater than the predetermined threshold.

Another aspect of the present disclosure is a program for causing a computer to transmit, to a predetermined server, identification information of a rotation sensor configured to be attached to an object that rotates at a time of being consumed and to detect the number of rotations performed, and identification information of a user, and receive, from the server, a notification according to a predetermined process regarding replenishment of the object, in a case where a consumed quantity of the object is determined by the server to be at or greater than a predetermined threshold based on the number of rotations from the rotation sensor. The computer is a user terminal, for example. The program is an application program that is installed in the user terminal, for example. When the user terminal executes the program, a user of the user terminal may grasp that the process is executed, based on the notification, by the server, according to the process regarding replenishment of the object, and stock management of the object may be facilitated.

According to another aspect of the present disclosure, the rotation sensor may be attachable to the object. In this case, the program may cause the computer to read a code attached to the object to acquire information about a first product corresponding to the object, and transmit the information about the first product to the server. In this case, the server may include a storage configured to hold the predetermined threshold for a plurality of products, receive the information about the first product, and identify the predetermined threshold for the first product. The rotation sensor may thus be mounted on a plurality of products, and appropriate stock management may be performed for each product corresponding to the object where the rotation sensor is mounted.

According to another aspect of the present disclosure, the program may cause the computer to receive a notification of consumption of the object, as the notification, by the server, according to the predetermined process. Furthermore, the program may cause the computer to receive, as the notification, by the server, according to the predetermined process, a notification indicating that an order is placed to a predetermined store such that a predetermined quantity of the object is delivered to a predetermined location specified by the user. By such notifications, the user may grasp that the predetermined process regarding replenishment of the object is performed, and may grasp a stock state of the object.

Moreover, another aspect of the present disclosure may be specified as a method that the above information processing device performs the above processes.

In the following, an embodiment of the present invention will be described with reference to the drawings. Configurations of the embodiment below are examples, and the present invention is not limited to the configurations of the embodiment.

### First Embodiment

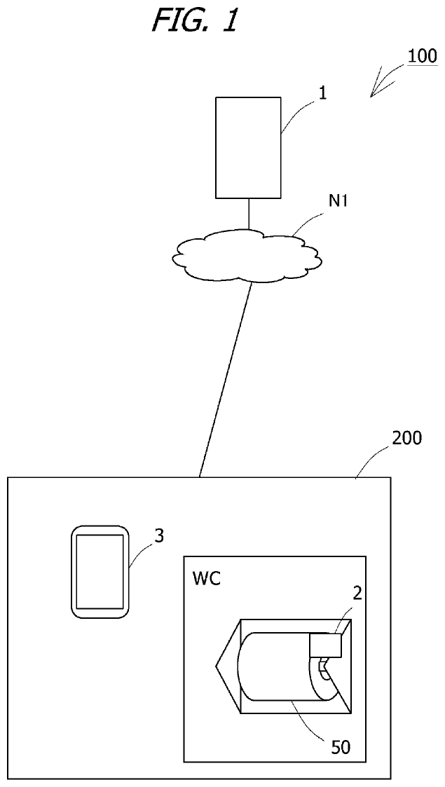

FIG. 1 is a diagram illustrating an example configuration of a stock management system 100 according to a first embodiment. The stock management system 100 is a system that manages stock of consumable items such as daily necessities. For example, the stock management system 100 includes a center server 1, a sensor device 2, and a user terminal 3. Additionally, a plurality of sensor devices 2 and user terminals 3 may be included in the stock management system 100, but FIG. 1 illustrates one sensor device 2 and one user terminal 3 for the sake of convenience.

In the first embodiment, a description is given citing a toilet roll 50 as a target of stock management. However, the daily necessity as the target of stock management by the stock management system 100 is not limited to toilet roll. For example, roll-shaped daily necessities such as plastic wrap, packing tape, kitchen towel and the like may be targets of management by the stock management system 100.

For example, the sensor device 2 is a device that is singly sold. A user purchases the sensor device 2, mounts the sensor device 2 on a toilet roll 50 to be used, and sets the toilet roll 50 on a toilet roll holder. Furthermore, the user downloads and installs a client application of the stock management system 100 in the user terminal 3 that the user owns, and performs user registration in the stock management system 100 through the application. With respect to user registration in the stock management system 100, name of the user, address of a home 200 of the user, an identification number of the sensor device 2, information about a product corresponding to the toilet roll 50, and an action to be performed when a consumed quantity of the toilet roll 50 reaches a predetermined quantity are registered, for example. When expressions “product corresponding to the toilet roll 50” and “product corresponding to an object” are used, one product is specified as the target product. In contrast, when expressions “product equivalent to the toilet roll 50” and “product equivalent to an object” are used, the target product is not limited to one product, and may include a plurality of products of a same item as the toilet roll 50 or the object, for example. Furthermore, a product equivalent to the toilet roll 50 and a product equivalent to an object include a product corresponding to the toilet roll 50 and a product corresponding to the object.

The center server 1 and the user terminal 3 are connected to a network N1, and are capable of communicating with each other. The network N1 is the Internet, for example. However, the network N1 is not limited to the Internet. The sensor device 2 is capable of wireless communication, and may connect to the network N1 by wirelessly connecting to a relay device in the home 200 of the user, for example. Alternatively, the sensor device 2 may perform short-range wireless communication with the user terminal 3 and transmit information to the user terminal 3, and may transmit the information to the center server 1 through transmission of the information from the user terminal 3 to the center server 1.

The sensor device 2 detects rotation of itself, and transmits the number of rotations to the center server 1. When the number of rotations of the sensor device 2 reaches or exceeds a predetermined threshold, the center server 1 determines that the consumed quantity of the toilet roll 50 where the sensor device 2 is mounted is at or greater than a predetermined threshold, and performs an action specified by the user. The action to be performed in the case where the consumed quantity of the toilet roll 50 is determined to be at or greater than a predetermined threshold may be notification of consumption of the toilet roll 50 in a quantity at or greater than the predetermined threshold and/or automatic delivery of a product equivalent to the toilet roll 50. The action to be performed in the case where the consumed quantity of the toilet roll 50 is determined to be at or greater than the predetermined threshold is an example of “predetermined process regarding replenishment of object”.

In the first embodiment, the sensor device 2 is mounted on the toilet roll 50, and the center server 1 monitors the consumed quantity of the toilet roll 50 by monitoring the number of rotations of the sensor device 2, and performs a predetermined action when the consumed quantity of the toilet roll 50 reaches or exceeds the predetermined threshold. Accordingly, the user may grasp that the toilet roll 50 is consumed in a quantity at or greater than the predetermined threshold, or the toilet roll 50 may be automatically replenished, and stock management of the toilet roll 50 by the user may be facilitated.

<Sensor Device>

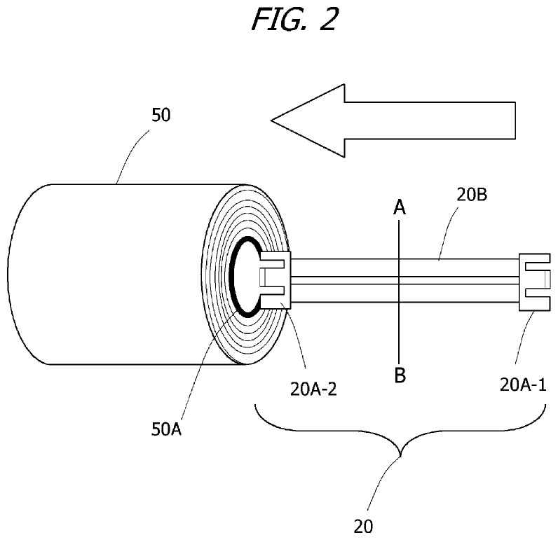

FIG. 2 is a diagram illustrating an example of an outer appearance of a housing of the sensor device 2. In the first embodiment, the housing of the sensor device 2 is attachable to the toilet roll 50. In the first embodiment, the housing of the sensor device 2 is cylindrical, as illustrated in FIG. 2, and is mounted by being inserted in a core 50A of the toilet roll 50. The housing of the sensor device 2 is made of plastic, for example.

The housing of the sensor device 2 includes fixing parts 20A-1 and 20A-2 provided on both ends, and a body part 20B. For example, the sensor device 2 is provided at the fixing part 20A-1.

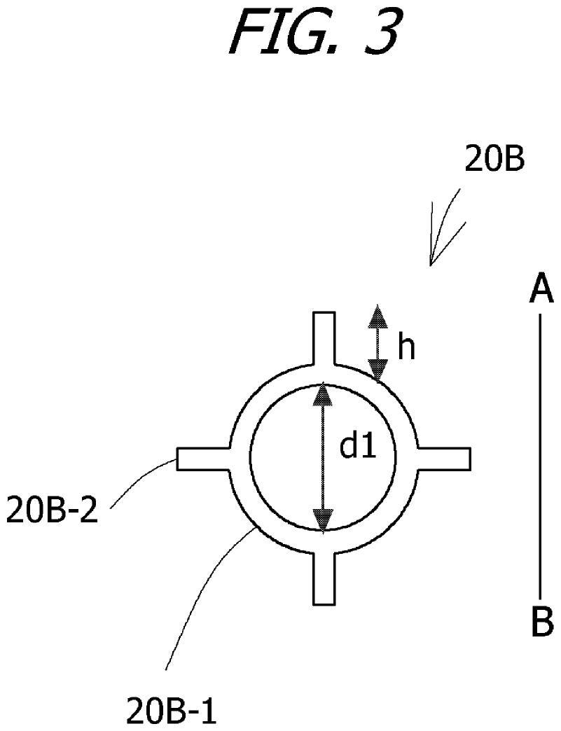

FIG. 3 is an example of a cross-section of the body part 20B of the housing of the sensor device 2. FIG. 3 illustrates a cross-sectional diagram of the body part 20B along a cross-section A-B in FIG. 2. The body part 20B includes a cylinder 20B-1, and four protrusions 20B-2 protruding from the cylinder 20B-1. An inner diameter d1 of a hollow in the cylinder 20B-1 is a size that allows a supporting part of a toilet roll holder to be inserted.

For example, the four protrusions 20B-2 are arranged every 90 degrees on an outer surface of the cylinder 20B-1. A height h of the four protrusions 20B-2 is such that ends away from the cylinder 20B-1 contact the core of the toilet roll 50.

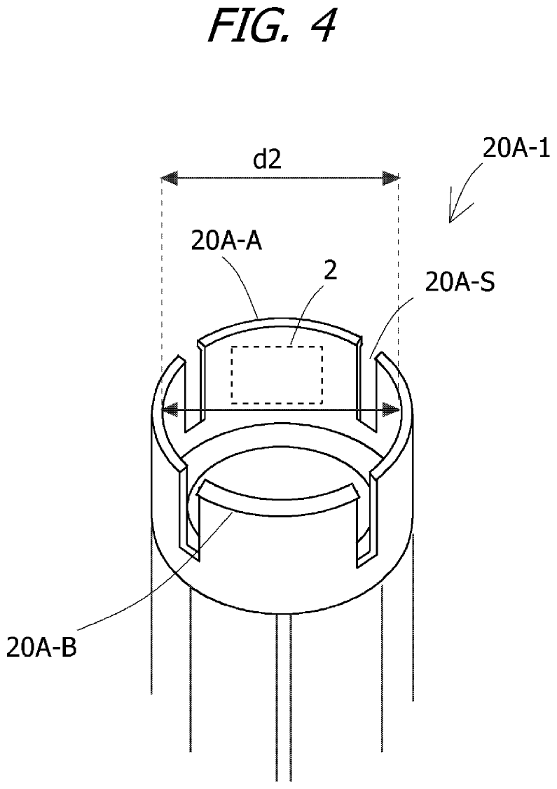

FIG. 4 is a diagram illustrating an example of an outer appearance of the fixing part 20A-1 of the housing of the sensor device 2. The fixing part 20A-1 is cylindrical, and an inner diameter d2 thereof has approximately a same length as an inner diameter of the core of the toilet roll 50. Four slits 20A-S are formed in the fixing part 20A-1, along a direction of the body part 20B, and claw parts 20A-A and 20A-B are formed on respective ends of two side surfaces that face each other, among side surfaces of the cylinder divided by the slits 20A-S. The claw parts 20A-A and 20A-B are formed such that the claw parts are thick and protrude outward than the cylinder forming the fixing part 20A-1, and the protrusions get hooked to the toilet roll 50 and the housing of the sensor device 2 is thus fixed to the toilet roll 50. Furthermore, because the four slits 20A-S are formed in the fixing part 20A-1, elasticity is generated in the side surfaces divided by the slits 20A-S, and the housing of the sensor device 2 may be easily inserted into the core of the toilet roll 50.

The sensor device 2 is provided on one side surface that is obtained by the division by the slits 20A-S of the fixing part 20A-1. Additionally, the fixing part 20A-2 has a same structure as the fixing part 20A-1, except that the sensor device 2 is not provided thereon.

For example, the sensor device 2 is provided on an inner side of the fixing part 20A-1. Additionally, the housing of the sensor device 2 illustrated in FIGS. 2 to 4 is an example, and the shape of the housing of the sensor device 2 is not limited thereto. For example, the housing of the sensor device 2 does not have to include the body part 20B, and may include just two parts, namely, the fixing part 20A-1 and the fixing part 20A-2.

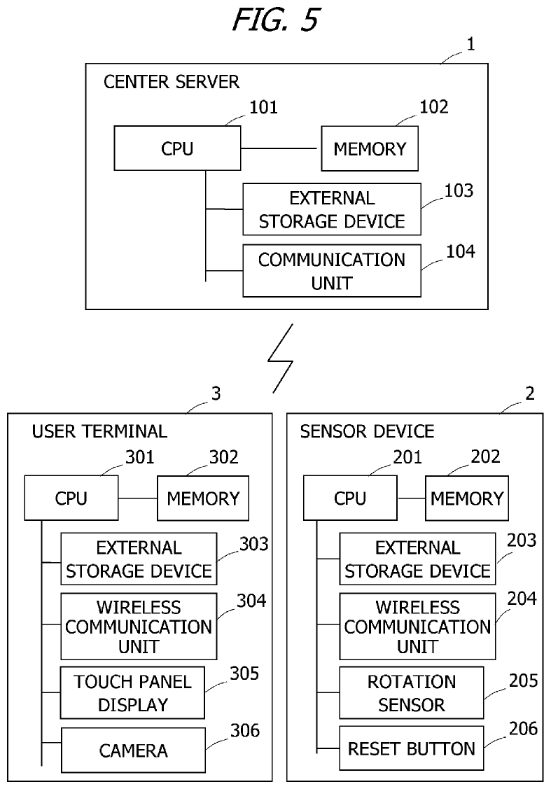

FIG. 5 is a diagram illustrating an example of a hardware configuration of the center server 1, the sensor device 2, and the user terminal 3 according to the first embodiment. As hardware components, the center server 1 includes a central processing unit (CPU) 101, a memory 102, an external storage device 103, and a communication unit 104. The memory 102 and the external storage device 103 are each a computer-readable recording medium. The center server 1 is an example of “information processing device”.

The external storage device 103 stores various programs, and data to be used by the CPU 101 at the time of execution of each program. For example, the external storage device 103 is an erasable programmable ROM (EPROM) and/or a hard disk drive. Programs to be held in the external storage device 103 include an operating system (OS), a control program of the stock management system 100, and various other application programs, for example. The control program of the stock management system 100 is a program for monitoring the consumed quantity of an object, and for controlling an action according to the consumed quantity of the object.

The memory 102 is a main memory that provides the CPU 101 with a work area and a storage area where programs stored in the external storage device 103 are loaded, and that is used as a buffer, for example. The memory 102 includes semiconductor memories such as a read only memory (ROM) and a random access memory (RAM), for example.

The CPU 101 performs various processes by loading the OS and various application programs held in the external storage device 103 into the memory 102 and executing the same. The number of CPUs 101 is not limited to one and may be more than one. The CPU 101 is an example of “processor”.

The communication unit 104 is an interface through which information is input/output from/to the network. For example, the communication unit 104 is a local area network (LAN) card. However, the communication unit 104 is not limited thereto, and may alternatively be an optical network unit (ONU) interface for an optical communication network, for example. The hardware configuration of the center server 1 is not limited to the one illustrated in FIG. 5.

As hardware components, the sensor device 2 includes a CPU 201, a memory 202, an external storage device 203, a wireless communication unit 204, a rotation sensor 205, and a reset button 206. The CPU 201, the memory 202, and the external storage device 203 are the same as the CPU 101, the memory 102, and the external storage device 103, respectively.

The wireless communication unit 204 is an interface through which information is input/output from/to the network. For example, the wireless communication unit 204 accesses the network N1 and communicates with the center server 1 by performing wireless communication through WiFi, Bluetooth (registered trademark) Low Energy (BLE) or the like and connecting to an access point installed at the home 200 of the user or the user terminal 3.

The rotation sensor 205 detects rotation of itself. When rotation of itself is detected, the rotation sensor 205 outputs a pulse signal, for example. The rotation sensor 205 is at least one or a combination of an accelerometer, an angular velocity sensor and the like. For example, the CPU 201 detects the pulse signal from the rotation sensor 205, and counts the number of rotations. Additionally, the hardware configuration of the sensor device 2 is not limited to the one illustrated in FIG. 5.

When the reset button 206 is pressed, a predetermined signal is input to the CPU 201, and the CPU 201 resets, that is, sets to zero, the number of rotations detected by the rotation sensor 205. For example, when the toilet roll 50 is consumed and is replaced by another toilet roll 50, the sensor device 2 is also reattached, and the user is instructed to press the reset button 206 at a timing of reattaching the sensor device 2. This instruction is given in a handbook for the sensor device 2, or in a description in a client application program of the stock management system 100.

Next, the user terminal 3 is a smartphone, a tablet terminal, a wearable terminal, or a personal computer (PC), for example. As hardware components, the user terminal 3 includes a CPU 301, a memory 302, an external storage device 303, a wireless communication unit 304, a touch panel display 305, and a camera 306, for example. The CPU 301, the memory 302, and the external storage device 303 are the same as the CPU 101, the memory 102, and the external storage device 103, respectively. However, the client application program of the stock management system 100 is stored in the external storage device 303 of the user terminal 3.

The wireless communication unit 304 is a wireless communication circuit for a mobile communication system such as WiFi, 4G (Generation), 5G or the like. The wireless communication unit 304 may also include a communication circuit for BLE. A plurality of wireless communication units 304 are provided for different wireless communication methods. In this case, at least one wireless communication unit 304 is used for connection to the network N1. Furthermore, at least one wireless communication unit 304 is used for connection to the sensor device 2. For example, the wireless communication unit 304 compatible with a communication method of a mobile communication system such as WiFi, 4G, 5G or the like is used in relation to the network N1. For example, the wireless communication unit 304 for WiFi or BLE is used for connection to the sensor device 2.

The touch panel display 305 receives an operation input from the user, and outputs the same to the CPU 301. Furthermore, the touch panel display 305 displays an image that is input from the CPU 301.

In the first embodiment, the camera 306 is used to capture a barcode or a QR code (registered trademark) printed on packaging of the toilet roll 50. An image, captured by the camera 306, including the barcode or the QR code is output to the CPU 301, and the CPU 301 analyzes the barcode or the QR code, and acquires information. Additionally, the hardware configurations of the center server 1, the sensor device 2, and the user terminal 3 illustrated in FIG. 5 are merely examples, and are not restrictive.

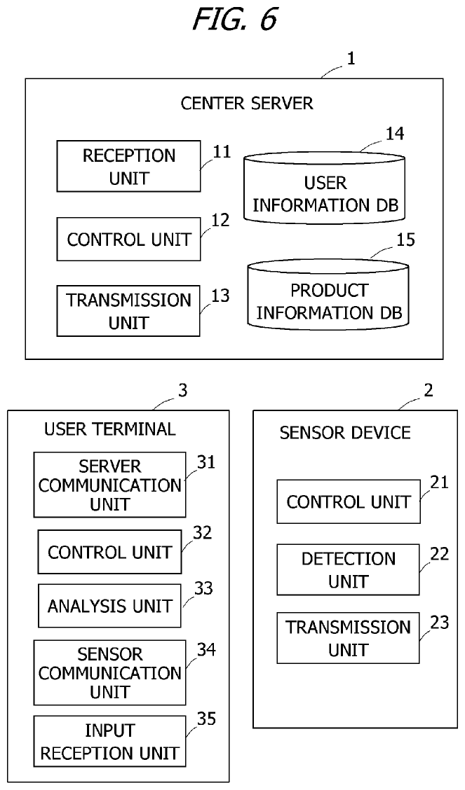

FIG. 6 is a diagram illustrating an example of a functional configuration of the center server 1, the sensor device 2, and the user terminal 3 according to the first embodiment. First, the user terminal 3 includes, as functional components, a server communication unit 31, a control unit 32, an analysis unit 33, a sensor communication unit 34, and an input reception unit 35. These functional components are implemented by the CPU 301 of the user terminal 3 executing an application program of the stock management system 100, for example.

The server communication unit 31 is an interface to the center server 1, and receives and transmits information from and to the center server 1 over the network N1. The server communication unit 31 outputs information received from the center server 1 to the control unit 32. The server communication unit 31 transmits information input from the control unit 32 to the center server 1 over the network N1.

The sensor communication unit 34 is an interface to the sensor device 2, and receives rotation number information from the sensor device 2. Details of the rotation number information from the sensor device 2 will be given later. The sensor communication unit 34 outputs the rotation number information received from the sensor device 2 to the control unit 32, and the control unit 32 outputs the rotation number information to the server communication unit 31, and the server communication unit 31 transmits the rotation number information to the center server 1. Additionally, the rotation number information is received from the sensor device 2 in a case where the sensor device 2 and the user terminal 3 are connected by a short-range wireless communication method such as BLE or the like. In a case where the sensor device 2 directly communicates with the center server 1 by a wireless communication method that allows direct connection to the network N1, the sensor communication unit 34 is not activated. Which method is to be used for transmission of the rotation number information by the sensor device 2 depends on the capacity of the sensor device 2 or selection of the user, for example.

The input reception unit 35 receives input of a user operation performed on the touch panel display 305. The input reception unit 35 outputs the user operation to the control unit 32.

The analysis unit 33 receives input of an image including the barcode or the QR code printed on the packaging of the toilet roll 50, captured by the camera 306 by user operation, analyzes the barcode or the QR code, and acquires information about a product corresponding to the toilet roll 50. Generally, a barcode or a QR code printed on packaging includes identification information of a manufacturer of the product and identification information of the product. That is, the information about a product corresponding to the toilet roll 50 at least includes the identification information of the manufacturer of the product and the identification information of the product. Additionally, the barcode or the QR code does not have to be printed on the packaging, and may alternatively be printed on a main body of the object where the sensor device 2 is to be mounted. The analysis unit 33 outputs the acquired information about the product corresponding to the toilet roll 50 to the control unit 32.

For example, in the case where a user operation instructing that transmission be performed is input from the input reception unit 35, the control unit 32 transmits user information input by a user operation performed up to then to the center server 1 through the server communication unit 31. The user information that is transmitted to the center server 1 includes at least one of identification information, name and address of the user, identification information of the sensor device 2, the information about a product corresponding to the toilet roll 50, an action desired to be performed when the consumed quantity of the toilet roll 50 reaches or exceeds a predetermined threshold, and specification of an order destination in a case where automatic delivery of a product equivalent to the toilet roll 50 is desired, for example.

Furthermore, when a notification is received from the center server 1 through the server communication unit 31, the control unit 32 outputs the notification by a predetermined method. The notification to be received from the center server 1 is a consumption notification indicating that the consumed quantity of the toilet roll 50 is at or greater than a predetermined threshold, or an automatic delivery notification indicating that the toilet roll 50 will be automatically delivered, for example.

Next, the sensor device 2 includes, as functional components, a control unit 21, a detection unit 22, and a transmission unit 23. These functional components are implemented by the CPU 201 of the sensor device 2 executing a predetermined program in the external storage device 203.

The detection unit 22 detects a signal that is output when rotation of the sensor device 2 is detected by the rotation sensor 205, and outputs a rotation detection notification indicating that rotation is detected to the control unit 21. The control unit 21 adds one to the number of rotations every time the rotation detection notification is received from the detection unit 22. An initial value of the number of rotations is zero. Furthermore, when input of a signal indicating that the reset button 206 is pressed is received, the control unit 21 resets the number of rotations.

In the case where communication with the center server 1 is established, the control unit 21 generates the rotation number information every time there is a change in the number of rotations, and outputs the same to the transmission unit 23. For example, in the case where communication with the center server 1 can be performed only through the user terminal 3 by short-range wireless communication such as BLE, if the user terminal 3 is not within a range where short-range wireless communication is possible, the rotation number information is not transmitted to the center server 1 even when there is a change in the number of rotations. In such a case, when short-range wireless communication with the user terminal 3 is established, the control unit 21 generates the rotation number information including the number of rotations at this point, and outputs the same to the transmission unit 23. The rotation number information includes the identification information of the sensor device 2 and the number of rotations, for example.

When the rotation number information is input from the control unit 21, the transmission unit 23 transmits the rotation number information to the center server 1 by the method of communication that is established.

Next, as functional components, the center server 1 includes a reception unit 11, a control unit 12, a transmission unit 13, a user information database (DB) 14, and a product information DB 15. These functional components are implemented by the CPU 101 executing the control program of the stock management system 100.

The reception unit 11 receives the user information and the rotation number information from the user terminal 3 over the network N1. In the case where the sensor device 2 performs communication by a wireless communication method that allows direct connection to the network N1, the reception unit 11 receives the rotation number information from the sensor device 2. The reception unit 11 outputs the received information to the control unit 12. The transmission unit 13 transmits information input from the control unit 12 to the user terminal 3 over the network N1.

When input of the user information is received from the reception unit 11, the control unit 12 registers contents thereof in the user information DB 14. When input of the rotation number information is received, the control unit 12 determines whether the number of rotations of the sensor device 2 is at or greater than a predetermined threshold. In the case where the number of rotations of the sensor device 2 is at or greater than a predetermined threshold, the control unit 12 performs an action that is specified by the user who is associated with the sensor device 2.

In the case where the action that is specified by the user is notification, the control unit 12 transmits the consumption notification indicating that the toilet roll 50 is consumed in a quantity at or greater than a predetermined threshold, to the user terminal 3 of the user through the transmission unit 13. In the case where the action that is specified by the user is automatic delivery, the control unit 12 places an order for a predetermined quantity of product equivalent to the toilet roll 50 to a server of a predetermined store, and requests for delivery. Furthermore, the control unit 12 transmits the automatic delivery notification indicating that a predetermined quantity of product equivalent to the toilet roll 50 will be automatically delivered, to the user terminal 3 of the user through the transmission unit 13.

The user information DB 14 and the product information DB 15 are created in a storage area in the external storage device 103. The user information DB 14 stores information about the user. The product information DB 15 stores information about the product. Details of information stored in the user information DB 14 and the product information DB 15 will be given later.

Additionally, the functional configuration of the center server 1, the sensor device 2, and the user terminal 3 illustrated in FIG. 6 are an example, and the functional configurations of the center server 1, the sensor device 2, and the user terminal 3 are not limited to those illustrated in FIG. 6.

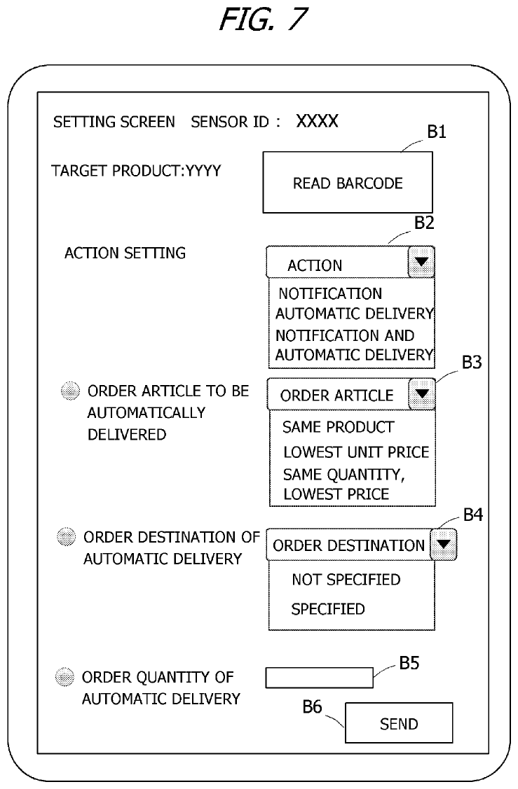

FIG. 7 is an example of a setting screen on the user terminal 3. The setting screen is a screen where settings may be performed in relation to information about an object where the sensor device 2 is mounted, an action that is to be performed when the consumed quantity of the object where the sensor device 2 is mounted reaches or exceeds a predetermined threshold, an order destination and an order quantity in a case where automatic delivery is to be performed, and the like. The setting screen is included in an application program of the stock management system 100, for example.

The identification information (a sensor ID) of the sensor device 2 that is used by the user is included in the setting screen illustrated in FIG. 7. The identification information of the sensor device 2 may be information that is attached to the housing of the sensor device 2 and that is input by the user, or may be acquired from the sensor device 2 by short-range wireless communication between the sensor device 2 and the user terminal 3, for example. The identification information of the sensor device 2 is input at a time of initial setting, and input thereof does not have to be performed in subsequent setting screens.

The setting screen illustrated in FIG. 7 displays the name of a manufacturer of a product corresponding to the object where the sensor device 2 is mounted and the name of the product. At a time of registration of the object where the sensor device 2 is mounted, when the user selects a barcode read button B1, the camera 306 is activated, and the screen transitions to a screen for reading the barcode. The barcode or the QR code is usually printed on the packaging of the object where the sensor device 2 is mounted or on the object itself, for example. When the barcode or the QR code is read, and the identification information of the manufacturer and the identification information of the product are acquired, for example, the user terminal 3 acquires the name of the manufacturer and the name of the product from the web, for example, and the name of the manufacturer of the product and the name of the product are displayed on the setting screen. In relation to the name of the manufacturer of the product corresponding to the object where the sensor device 2 is mounted and the name of the product, the acquired names of the manufacturer and the product are displayed until the names are changed by selection of the barcode read button B1. Additionally, the size, net contents and the like of the product may be included in the name of the product. Additionally, in the first embodiment, products with different net contents and sizes are recognized to be different products even when the products are of the same brand.

The setting screen illustrated in FIG. 7 includes an action menu bar B2 used to select an action that is to be performed when the consumed quantity of the object where the sensor device 2 is mounted reaches or exceeds a predetermined threshold. Options of the action menu bar B2 include “notification”, “automatic delivery”, and “notification and automatic delivery”. In the case where the option “notification” is selected, a notification indicating that the consumed quantity of the object is at or greater than a predetermined threshold is issued. In the case where the option “automatic delivery” is selected, a product equivalent to the object is automatically delivered. In the case where the option “notification and automatic delivery” is selected, the notification indicating that the consumed quantity of the object is at or greater than a predetermined threshold is issued, and a product equivalent to the object is automatically delivered.

With the setting screen illustrated in FIG. 7, in the case where the option “automatic delivery” or “notification and automatic delivery” is selected by the action menu bar B2, an order article menu bar B3 for selecting an order article to be automatically delivered, an order destination menu bar B4 for selecting the order destination of the automatic delivery, and an input section B5 for the order quantity for automatic delivery are displayed.

The order article menu bar B3 includes options related to a relationship between a product equivalent to the object where the sensor device 2 is mounted and the product to be ordered to be automatically delivered. The options of the order article menu bar B3 include “same product”, “lowest unit price”, and “same quantity, lowest price”. In the case where the option “same product” is selected, an order is placed for a product that is the same as the product equivalent to the object where the sensor device 2 is mounted. In the case where the option “lowest unit price” is selected, an order is placed for a product that is of a same item as the object where the sensor device 2 is mounted and with a lowest unit price. In the case where the option “same quantity, lowest price” is selected, an order is placed for a product that is of a same item as the product corresponding to the object where the sensor device 2 is mounted and with a lowest price for a same quantity or a same size.

Options of the order destination menu bar B4 for selecting the order destination for automatic delivery include “not specified” and “specified”. In the case of the option “not specified”, a store where the product according to the option in the order article menu bar B3 is the cheapest is selected as the order destination, for example. In the case of the option “specified”, an input section or an option for specifying a store desired by the user is displayed, and an order is placed to a store that is specified.

An order quantity specified by the user can be input in the input section B5 for the order quantity for automatic delivery. For example, a unit according to the object where the sensor device 2 is mounted is displayed following the input section B5 for the order quantity for automatic delivery.

A send button B6 is arranged at a lowest position on the setting screen illustrated in FIG. 7. When the send button B6 is selected, contents set on the setting screen are transmitted to the center server 1 as a part of the user information.

Specific examples will be cited in relation to a case where the object where the sensor device 2 is mounted is the toilet roll 50. A product A corresponding to the toilet roll 50 is assumed to be a product including 12 rolls of 1-ply, 50-meter rolls.

For example, in the case where “automatic delivery” is selected in the action menu bar B2, the option “same product” is selected in the order article menu bar B3, “not specified” is selected in the order destination menu bar B4, and “one” is specified as the order quantity, an order for one product A is placed, at the time of automatic delivery, to a store that sells the product A at the lowest price. Furthermore, in this case, the user information transmitted to the center server 1 includes the identification information of the user, the identification information of the sensor device 2, the identification information of the product corresponding to the object where the sensor device 2 is mounted, the option “automatic delivery” selected in the action menu bar B2, the option “same product” selected in the order article menu bar B3, the option “not specified” selected in the order destination menu bar B4, and “one” as the order quantity, for example.

For example, in the case where “automatic delivery” is selected in the action menu bar B2, the option “same quantity, lowest price” is selected in the order article menu bar B3, “not specified” is selected in the order destination menu bar B4, and “one” is specified as the order quantity, an order for one product B is placed, at the time of automatic delivery, to a store that sells, at a lowest price, the product B that is the cheapest product that, like the product A, includes 12 rolls of 1-ply, 50-meter rolls. Additionally, in the case where the product A is the cheapest product among products including 12 rolls of 1-ply, 50-meter rolls, the product B is the product A. Furthermore, in this case, the user information transmitted to the center server 1 includes the identification information of the user, the identification information of the sensor device 2, the identification information of the product corresponding to the object where the sensor device 2 is mounted, the option “automatic delivery” selected in the action menu bar B2, the option “same quantity, lowest price” selected in the order article menu bar B3, the option “not specified” selected in the order destination menu bar B4, and “one” as the order quantity, for example.

Additionally, the setting screen illustrated in FIG. 7 is an example, and items that can be set on the setting screen, options of each item, and the like are not limited to those illustrated in FIG. 7.

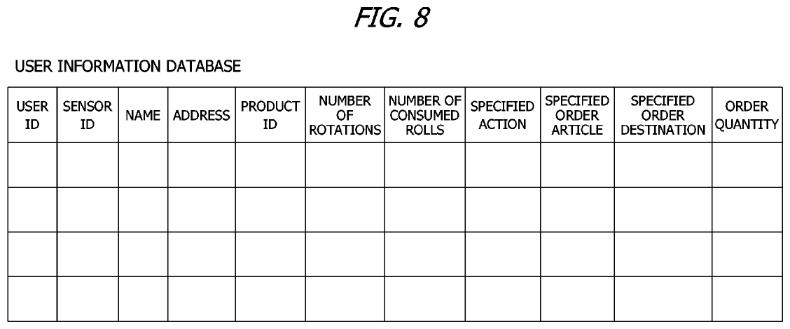

FIG. 8 is an example of information pieces stored in the user information DB 14 of the center server 1. FIG. 8 is an example of information pieces that are stored in the user information DB 14 in the case where the user information is generated according to input that is performed by the user on the setting screen illustrated in FIG. 7 using the user terminal 3. The user information DB 14 is managed by the control unit 12.

One record in the user information DB 14 includes the following fields: user ID, sensor ID, name, address, product ID, number of rotations, number of consumed rolls, specified action, specified order article, specified order destination, and order quantity.

The identification information of the user who is registered for the service of the stock management system 100 is stored in the field “user ID”. The identification information of the sensor device 2 is stored in the field “sensor ID”. The name and address of the user are stored in the fields “name” and “address”, respectively. The value in the field “address” is the address of the delivery destination of a product that is to be automatically delivered. Furthermore, the address indicated by the value in the field “address” is the address including a location where the sensor device 2 is used. Additionally, the delivery destination of a product that is to be automatically delivered is not limited to the home 200.

The identification information of the manufacturer of a product corresponding to the object where the sensor device 2 is mounted and the identification information of the product are stored in the field “product ID”. The identification information of the manufacturer of a product corresponding to the object where the sensor device 2 is mounted and the identification information of the product are included in the user information from the user terminal 3.

The number of rotations of the sensor device 2 is stored in the field “number of rotations”. The number of rotations of the sensor device 2 is included in the rotation number information transmitted from the sensor device 2, and is updated every time the rotation number information is received.

The number of consumed rolls is stored in the field “number of consumed rolls”. One is added to the value in the field “number of consumed rolls” when the reset button 206 of the sensor device 2 is pressed and the rotation number information (including zero rotation) indicating that the number of rotations is reset is received, for example. The field “number of consumed rolls” is reset when the value reaches the number of rolls included in the product.

For example, in the case where the product indicated by the value in the field “product ID” is a product where one product includes a plurality of rolls, whether the consumed quantity of the product is at or greater than a predetermined threshold is determined by taking into account the value in the field “number of rotations” and the value in the field “number of consumed rolls”. For example, in the case of a product such as the toilet roll 50 where one product includes 12 rolls, two thresholds, namely, a rotation number threshold related to the number of rotations and a roll number threshold related to the number of rolls, are used. The control unit 12 performs an action that is specified by the user, in a case where the number of rotations is at or greater than the rotation number threshold and the number of consumed rolls is at or greater than the roll number threshold. Additionally, in the case where one product includes one roll, such as in the case of plastic wrap or aluminum foil, the field “number of consumed rolls” is empty, and the roll number threshold related to the number of rolls is not set.

A value indicating an action that is specified by the user to be performed in a case where the consumed quantity of the object where the sensor device 2 is mounted reaches or exceeds a predetermined threshold is stored in the field “specified action”. The value indicating an action is a code or a flag, for example. A value indicating one of “notification”, “automatic delivery”, and “notification and automatic delivery” is stored in the field “specified action”, for example. A value indicating the option that is selected in the action menu bar B2 in FIG. 7 and that is included in the user information is stored in the field “specified action”, for example. Accordingly, types of values that can be included in the field “specified action” in FIG. 8 match types of options in the action menu bar B2 in FIG. 7.

A value indicating a relationship, specified by the user, between a product corresponding to the object where the sensor device 2 is mounted and a product to be ordered to be automatically delivered is stored in the field “specified order article”. The value indicating a relationship between a product corresponding to the object where the sensor device 2 is mounted and a product to be ordered to be automatically delivered may be “same product”, “lowest unit price”, or “same quantity, lowest price”, for example. A value, included in the user information, indicating the option selected in the order article menu bar B3 is stored in the field “specified order article”, for example. Accordingly, types of values that can be included in the field “specified order article” in FIG. 8 match types of options in the order article menu bar B3 in FIG. 7.

Information indicating the store that is specified by the user is stored in the field “specified order destination”. In the case where an order destination is not specified by the user, a value indicating “not specified” is stored in the field “specified order destination”. For example, a value, included in the user information, indicating the option selected in the order destination menu bar B4 is stored in the field “specified order destination”. Accordingly, types of values that can be included in the field “specified order destination” in FIG. 8 match types of options in the order destination menu bar B4 in FIG. 7.

Information indicating the order quantity, specified by the user, for a product that is to be automatically delivered is stored in the field “order quantity”. For example, information indicating the order quantity included in the user information is stored in the field “order quantity”. Additionally, information pieces to be held in the user information DB 14 are not limited to those illustrated in FIG. 8.

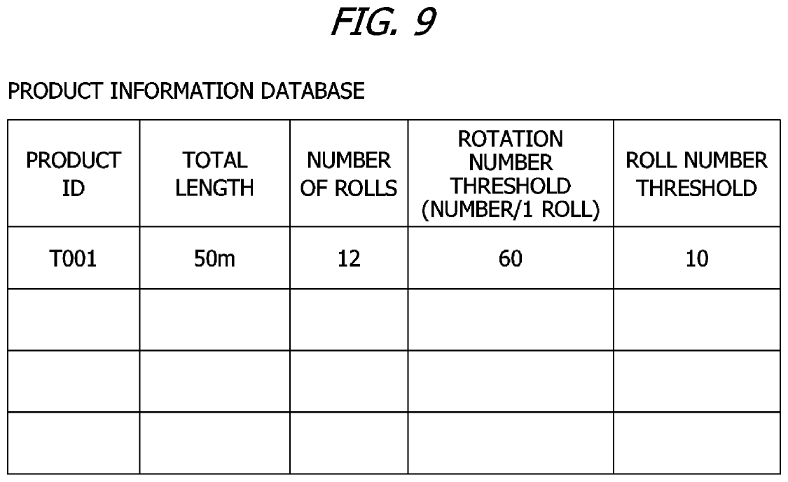

FIG. 9 is a diagram illustrating an example of information pieces stored in the product information DB 15 in the center server 1. Information about each of products is stored in the product information DB 15. One record in the product information DB 15 includes the following fields: product ID, total length, number of rolls, rotation number threshold, and roll number threshold.

The identification information of the manufacturer and the identification information of the product are stored in the field “product ID”. A value indicating a total length of one roll in the product is stored in the field “total length”. A value indicating the number of rolls included in one product is stored in the field “number of rolls”. The rotation number threshold related to the number of rotations per one roll of the product is stored in the field “rotation number threshold”. The roll number threshold related to the number of rolls in the product is stored in the field “roll number threshold”. In the case where the number of rolls included in one product is one, zero is stored in the field “roll number threshold”, or the field “roll number threshold” is empty.

The rotation number threshold and the roll number threshold are set based on a relationship between the number of rotations of a product and the consumed quantity or the remaining quantity that is checked in advance. Accordingly, when the number of rotations of the sensor device 2 mounted on an object reaches or exceeds the rotation number threshold, it can be estimated that the consumed quantity of the object is at or greater than a predetermined threshold. Additionally, information pieces to be stored in the product information DB 15 are not limited to those illustrated in FIG. 9.

<Flow of Processes>

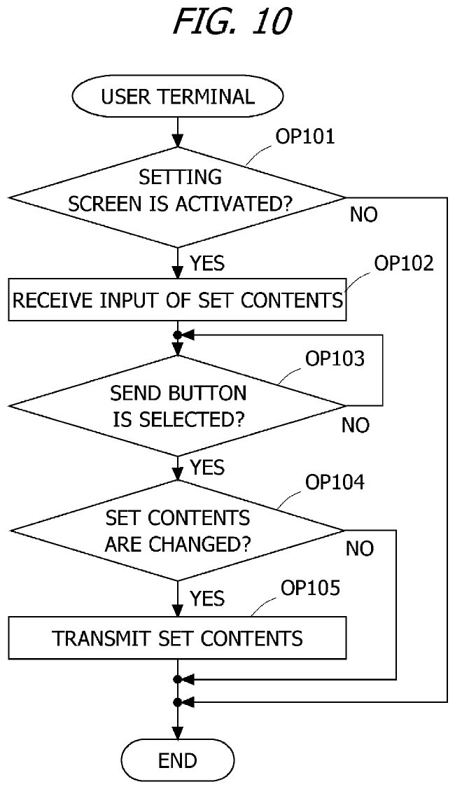

FIG. 10 is an example of a flowchart of a user information transmission process by the user terminal 3. The process illustrated in FIG. 10 is repeatedly performed by the user terminal 3 while the client application program of the stock management system 100 is active. The performer of the process illustrated in FIG. 10 is the CPU 301 of the user terminal 3, but a description will be given taking a functional component as the performer for the sake of convenience.

In OP101, the control unit 32 determines whether the setting screen is activated. In the case where the setting screen is activated (OP101: YES), the process proceeds to OP102. In the case where the setting screen is not activated (OP101: NO), the process illustrated in FIG. 10 is ended. The setting screen is activated by a user operation.

In OP102, the control unit 32 receives input of set contents on the setting screen, through the input reception unit 35. The set contents on the setting screen are as described with reference to FIG. 7, for example.

In OP103, the control unit 32 determines whether a user operation of selecting the send button B6 is input through the input reception unit 35. In the case where a user operation of selecting the send button B6 is input through the input reception unit 35 (OP103: YES), the process proceeds to OP104. In the case where a user operation of selecting the send button B6 is not input through the input reception unit 35 (OP103: NO), the process in OP103 is repeated. For example, the process illustrated in FIG. 10 is ended when the setting screen is closed without the send button B6 being selected.

In OP104, the control unit 32 determines whether there is a change in the set contents input on the setting screen. In the case where there is a change in the set contents input on the setting screen (OP104: YES), the process proceeds to OP105. In the case where there is no change in the set contents input on the setting screen (OP104: NO), the process illustrated in FIG. 10 is ended.

In OP105, the control unit 32 generates the user information including the set contents input on the setting screen, and transmits the same to the center server 1 through the server communication unit 31. The identification information of the user is also included in the user information. Then, the process illustrated in FIG. 10 is ended, and display of the setting screen is also ended.

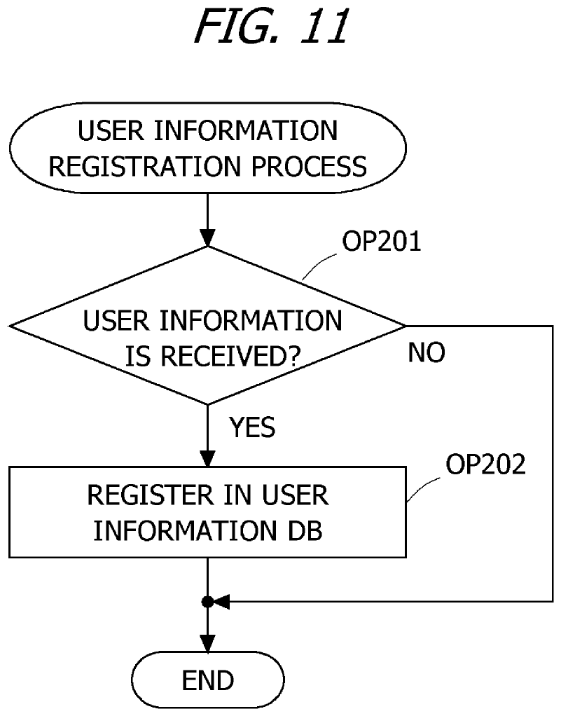

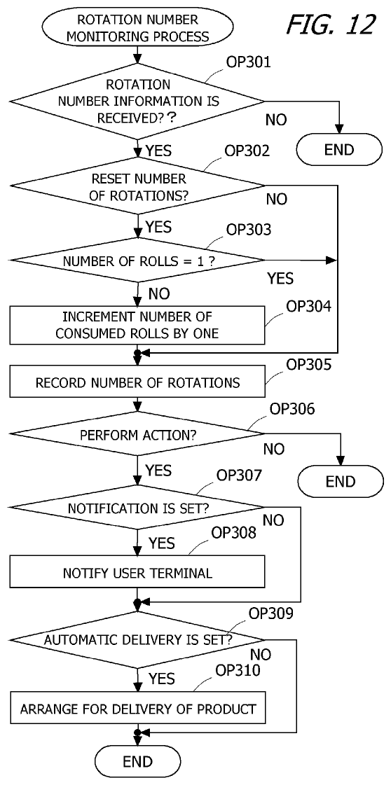

FIG. 11 is an example of a flowchart of a user information management process by the center server 1. The process illustrated in FIG. 11 is repeated every predetermined period of time while the center server 1 is in operation. The performer of the process illustrated in FIG. 11 is the CPU 101 of the center server 1, but a description will be given taking a functional component as the performer for the sake of convenience. The same applies to the flowchart in FIG. 12.

In OP201, the control unit 12 determines whether the user information is received from the user terminal 3 through the reception unit 11. In the case where the user information is received (OP201: YES), the process proceeds to OP202. In the case where the user information is not received (OP201: NO), the process illustrated in FIG. 11 is ended.

In OP202, the control unit 12 registers the received user information in the user information DB 14. In the case where there is a record whose field “user ID” includes a value matching the identification information of the user included in the received user information, the control unit 12 updates the record according to the received user information. Then, the process illustrated in FIG. 11 is ended.

FIG. 12 is an example of a flowchart of a rotation number monitoring process by the center server 1. The process illustrated in FIG. 12 is repeated every predetermined period of time while the center server 1 is in operation.

In OP301, the control unit 12 determines whether the rotation number information is received through the reception unit 11. In the case where the rotation number information is received (OP301: YES), the process proceeds to OP302. In the case where the rotation number information is not received (OP301: NO), the process illustrated in FIG. 12 is ended.

In OP302, the control unit 12 determines whether the received rotation number information indicates reset (=0) of the number of rotations. In the case where the received rotation number information indicates reset (=0) of the number of rotations (OP302: YES), the process proceeds to OP303. In the case where the received rotation number information does not indicate reset (=0) of the number of rotations (OP302: NO), the process proceeds to OP305.

In OP303, the control unit 12 specifies, by referring to the user information DB 14, the product corresponding to the identification information of the sensor device 2 included in the received rotation number information, acquires, by referring to the product information DB 15, the number of rolls included in the product, and determines whether the number of rolls in the product is one. In the case where the number of rolls included in the product corresponding to the identification information of the sensor device 2 included in the received rotation number information is one (OP303: YES), the process proceeds to OP305. In the case where the number of rolls included in the product corresponding to the identification information of the sensor device 2 included in the received rotation number information is not one (OP303: NO), the process proceeds to OP304.

In OP304, the control unit 12 updates, by addition of one, the value in the field “number of consumed rolls” of the record, in the user information DB 14, whose field “sensor ID” includes a value matching the identification information of the sensor device 2 included in the received rotation number information. In the following, the record whose field “sensor ID” includes a value matching the identification information of the sensor device 2 included in the received rotation number information will be referred to as a target record in the user information DB 14.

In OP305, the control unit 12 updates the value in the field “number of rotations” of the target record in the user information DB 14 by the number of rotations included in the received rotation number information. In OP306, the control unit 12 determines whether to perform the action specified by the user. With respect to the determination in OP306, a positive determination is made in the case where the value in the field “number of rotations” of the target record is at or greater than the rotation number threshold and the value in the field “number of consumed rolls” of the target record is at or greater than the roll number threshold, for example, and a negative determination is made in other cases. The rotation number threshold and the roll number threshold are acquired from the product information DB 15.

In the case where the action specified by the user is determined to be performed (OP306: YES), the process proceeds to OP307. In the case where the action specified by the user is determined not to be performed (OP306: NO), the process illustrated in FIG. 12 is ended.

In OP307, the control unit 12 determines whether the value in the field “specified action” of the target record in the user information DB 14 is a value indicating “notification” or “notification and automatic delivery”. In the case where the value in the field “specified action” of the target record in the user information DB 14 is a value indicating “notification” or “notification and automatic delivery” (OP307: YES), the process proceeds to OP308. In the case where the value in the field “specified action” of the target record in the user information DB 14 is not a value indicating “notification” or “notification and automatic delivery” (OP307: NO), the process proceeds to OP309.

In OP308, the control unit 12 transmits to the user terminal 3, through the transmission unit 13, the consumption notification indicating that the consumed quantity of the object where the sensor device 2 is mounted is at or greater than a predetermined threshold. In OP309, the control unit 12 determines whether the value in the field “specified action” of the target record in the user information DB 14 is a value indicating “automatic delivery” or “notification and automatic delivery”. In the case where the value in the field “specified action” of the target record in the user information DB 14 is a value indicating “automatic delivery” or “notification and automatic delivery” (OP309: YES), the process proceeds to OP310. In the case where the value in the field “specified action” of the target record in the user information DB 14 is not a value indicating “automatic delivery” or “notification and automatic delivery” (OP309: NO), the process illustrated in FIG. 12 is ended.

In OP310, the control unit 12 makes arrangement for delivery of a product according to the values in the fields “specified order article”, “specified order destination”, and “order quantity” of the target record in the user information DB 14. Arrangement for delivery of a product includes specification of the order article and the order destination, a process of placing the order, and transmission, to the user terminal 3, of the automatic delivery notification indicating that the product will be automatically delivered. The automatic delivery notification also includes a scheduled delivery date, information about the order article, information about the order destination, and the order quantity, for example. Then, the process illustrated in FIG. 12 is ended.

<Operations and Effects of First Embodiment>

In the first embodiment, the consumed quantity of an object that rotates at the time of being consumed is monitored by monitoring the number of rotations of the object, and an action that is specified by the user is performed in the case where the consumed quantity reaches or exceeds a predetermined threshold. In the case where the action is notification indicating that the consumed quantity of the object is at or greater than the predetermined threshold, the user may be encouraged to replenish the product equivalent to the object. In the case where the action is automatic delivery of the product equivalent to the object, replenishment of the product equivalent to the object may be performed at a location where the object is consumed. Stock management of product equivalent to the object may thus be facilitated.

In the first embodiment, because the sensor device 2 is attachable to an object, the sensor device 2 may also be used at least on other products of the same item, for example. Furthermore, in the first embodiment, the user may set the order article, the order destination, and the order quantity in relation to automatic delivery, and thus, needs of the user may be flexibly met.

### Other Embodiments

The embodiment described above is an example, and the present disclosure may be changed and carried out as appropriate without departing from the gist of the present disclosure.

In the first embodiment, the sensor device 2 is attachable to an object, and the sensor device 2 is assumed to be singly sold, but such a case is not restrictive, and the sensor device 2 may be mounted in advance on each roll in the product. In this case, information indicating association between the sensor device 2 and the object where the sensor device 2 is mounted may be held in advance in the center server 1, and thus, the user terminal 3 may simply transmit the identification information of the sensor device 2 to the center server 1, and the process of reading the barcode on the packaging of the object may be omitted, for example.

At the time of consumption notification, information about a store that sells the object where the sensor device 2 is mounted at a lowest price, information about a different cheaper product that is of the same item as the object, and the like may also be notified to the user terminal 3, for example. The user may thus be given an opportunity to select a product.

Furthermore, in the first embodiment, a rotation sensor that counts the number of rotations of an object by rotating together with the object is adopted as the rotation sensor, but such a case is not restrictive, and a rotation sensor that is capable of counting the number of rotations of an object without rotating may alternatively be adopted. Furthermore, in the case where the rotation sensor that is capable of counting the number of rotations of an object without rotating is adopted, the sensor device 2 may be installed on the toilet roll holder. The rotation sensor that is capable of counting the number of rotations of an object without rotating includes a part that comes in contact with a part of the object at the time of rotation of the object, and the rotation sensor detects rotation of the object by detecting contact between the part of the object and the part of the rotation sensor by electrical conduction or the like, for example.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing device comprising a processor configured to:
acquire, from a rotation sensor, number of rotations performed by an object that rotates at a time of being consumed;
determine, based on the number of rotations from the rotation sensor, whether a consumed quantity of the object is at or greater than a predetermined threshold; and
perform a predetermined process regarding replenishment of the object, in a case where the consumed quantity of the object is determined to be at or greater than the predetermined threshold.

2. The information processing device according to claim 1, wherein, as the predetermined process, the processor notifies a user terminal associated with the rotation sensor of consumption of the object.

3. The information processing device according to claim 1, wherein, as the predetermined process, the processor places an order to a predetermined store such that a predetermined quantity of product equivalent to the object is delivered to a predetermined location that is specified by a user associated with the rotation sensor.

4. The information processing device according to claim 3, wherein the processor places the order to a store that is specified by the user.

5. The information processing device according to claim 3, wherein the processor places the order to a store that sells a same product as the object at a lowest price.

6. The information processing device according to claim 3, wherein the processor places the order to a store that sells a product of a same item as the object and with a lowest unit price.

7. The information processing device according to claim 3, wherein the processor notifies a user terminal associated with the rotation sensor that the order is placed.

8. The information processing device according to claim 1, wherein
the rotation sensor is attachable to the object,
the information processing device further comprises a storage configured to hold the predetermined threshold for a plurality of products, and
the processor is further configured to
acquire information about a first product corresponding to the object from a user terminal associated with the rotation sensor, and
identify the predetermined threshold for the first product.

9. An information processing system comprising:
a rotation sensor configured to detect number of rotations performed by an object that rotates at a time of being consumed; and
a processor configured to
acquire the number of rotations from the rotation sensor,
determine, based on the number of rotations from the rotation sensor, whether a consumed quantity of the object is at or greater than a predetermined threshold, and
perform a predetermined process regarding replenishment of the object, in a case where the consumed quantity of the object is determined to be at or greater than the predetermined threshold.

10. The information processing system according to claim 9, wherein, as the predetermined process, the processor notifies a user terminal associated with the rotation sensor of consumption of the object.

11. The information processing system according to claim 9, wherein, as the predetermined process, the processor places an order to a predetermined store such that a predetermined quantity of the object is delivered to a predetermined location that is specified by a user associated with the rotation sensor.

12. The information processing system according to claim 11, wherein the processor places the order to a store that is specified by the user.

13. The information processing system according to claim 11, wherein the processor places the order to a store that sells a same product as the object at a lowest price.

14. The information processing system according to claim 11, wherein the processor places the order to a store that sells a product of a same item as the object and with a lowest unit price.

15. The information processing system according to claim 11, wherein the processor notifies a user terminal associated with the rotation sensor that the order is placed.

16. The information processing system according to claim 9, wherein
the rotation sensor is attachable to the object,
the information processing system further comprises a storage configured to hold the predetermined threshold for a plurality of products, and
the processor is further configured to
acquire information about a first product corresponding to the object from a user terminal associated with the rotation sensor, and
identify the predetermined threshold for the first product.

17. A non-transitory computer-readable recording medium recorded with a program for causing a computer to:
transmit, to a server, identification information of a rotation sensor configured to detect number of rotations performed by an object that rotates at a time of being consumed, and identification information of a user; and
receive, from the server, a notification according to a predetermined process regarding replenishment of the object, in a case where a consumed quantity of the object is determined by the server to be at or greater than a predetermined threshold based on the number of rotations from the rotation sensor.

18. The non-transitory computer-readable recording medium recorded with the program according to claim 17, wherein
the rotation sensor is attachable to the object,
the program further causes the computer to
read a code attached to the object to acquire information about a first product corresponding to the object, and
transmit the information about the first product to the server, and
the server
includes a storage configured to hold the predetermined threshold for a plurality of products,
receives the information about the first product, and
identifies the predetermined threshold for the first product.

19. The non-transitory computer-readable recording medium recorded with the program according to claim 17, wherein the computer is caused to receive notification of consumption of the object, as the notification, by the server, according to the predetermined process.

20. The non-transitory computer-readable recording medium recorded with the program according to claim 17, wherein the computer is caused to receive, as the notification, by the server, according to the predetermined process, a notification indicating that an order is placed to a predetermined store such that a predetermined quantity of the object is delivered to a predetermined location specified by the user.
